(19) United States
(12) Patent Application Publication
(10) Pub. No.: US 2015/0161620 A1
(43) Pub. Date: Jun. 11, 2015

(54) SYSTEM AND METHOD FOR RISK AND FRAUD MITIGATION FOR MERCHANT ON-BOARDING

(71) Applicant: Cube, Co., Mountain View, CA (US)

(72) Inventor: Joel Christner, Mountain View, CA (US)

(73) Assignee: Cube, Co., Mountain View, CA (US)

(21) Appl. No.: 14/099,599

(22) Filed: Dec. 6, 2013

(51) Int. Cl. G06Q 30/00; G06F 17/30

(52) U.S. Cl. CPC G06Q 30/0185; G06F 17/30477

(57) ABSTRACT

A system and method is provided for detecting fraud during merchant on-boarding. A transaction processing system receives signup information from a merchant requesting to create a new merchant profile. The signup information may include input data specifying a bank account of the merchant and metadata associated with a device used to submit the input data. The system then compares the signup information with merchant information stored in a merchant database and selectively identifies the new merchant profile as fraudulent based, at least in part, on the comparison. For some embodiments, the system may identify the new merchant profile as fraudulent if the bank account specified by the input data matches bank account information associated with an existing merchant profile or a known fraudulent profile.

### TECHNICAL FIELD

Examples described herein relate to commercial transactions, and more specifically, to detecting and/or mitigating risk of fraud during merchant on-boarding.

### BACKGROUND

In recent years, point-of-sale devices and systems have implemented technology that takes advantage of the increasingly functional performance provided by consumer electronic devices such as smart phones and tablets. While in years past, point-of-sale devices were limited to cash registers and credit card terminals (e.g., magnetic readers), present day provides merchants with miniaturized accessory devices that can be connected to consumer electronic devices (e.g., tablets) that use software applications to process transactions and accept funds.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A system and method of operation are disclosed that may aid in fraud detection during merchant on-boarding. A transaction processing system receives signup information from a merchant requesting to create a new merchant profile. The signup information may include input data specifying a bank account of the merchant and metadata associated with a device used to submit the input data. For example, the input data specifying the bank account may include routing information, account information, and/or account type. The system then compares the signup information with merchant information stored in a merchant database and selectively identifies the new merchant profile as fraudulent based, at least in part, on the comparison. Specifically, the system may identify the new merchant profile as fraudulent if the bank account specified by the input data matches bank account information associated with an existing merchant profile or a known fraudulent profile.

For some embodiments, the system may compare the signup information with the merchant information associated with one or more existing merchant profiles to determine whether the new merchant profile is a duplicate of one of the existing merchant profiles. For other embodiments, the system may compare the signup information with a merchant blacklist to determine whether the merchant has been previously associated with a known fraudulent profile. For example, the metadata may include geolocation data indicating a location of the device when it was used to submit the input data. The system may compare the received geolocation data with geolocation data associated with one or more payments or chargebacks previously identified as fraudulent to determine whether the merchant is blacklisted. For example, the merchant may be blacklisted if the location of the device is within a threshold distance of a location where a fraudulent payment or chargeback previously occurred.

For some embodiments, the system may request additional information from the merchant, for example, if the system does not identify the new merchant profile as fraudulent. For example, the request may include out-of-wallet questions which may be used to verify the identity of the merchant. The system may then determine the veracity of the input data based on the additional information. Further, for some embodiments, the system may analyze one or more social networking profiles associated with the merchant and determine a social risk assessment for the merchant based on the one or more social networking profiles.

For some embodiments, the input data may further include personally-identifying information and/or business-identifying information. For example, the personally-identifying information may include a name, address, date of birth, social security number, phone number, email address, and/or password associated with an individual or operator. The business-identifying information may include, for example, a name, address, phone number, web address, and/or tax ID associated with a company or business. For some embodiments, the metadata may include a device type, device ID, IP address, and/or geolocation data indicating a location of the device when used to submit the input data.

By comparing various merchant-provided input data as well as device metadata with merchant information stored in a merchant database, the transaction processing system may identify and/or prevent the creation of new merchant profiles having a high risk of fraud. For example, there may be a high risk of fraud where the same bank account is used to create multiple merchant profiles. Additionally, the risk of creating a fraudulent merchant profile may be reduced even further, for example, by verifying the identity of the merchant based on out-of-wallet questions and/or analyzing one or more social networking profiles associated with the merchant.

### BRIEF DESCRIPTION OF THE DRAWINGS

The present embodiments are illustrated by way of example and are not intended to be limited by the figures of the accompanying drawings where:

FIG. 1 illustrates a system for conducting commercial transactions in accordance with some embodiments;

FIG. 2 is an illustrative flow chart depicting a merchant on-boarding fraud detection operation in accordance with some embodiments;

FIG. 3 is an illustrative flow chart depicting a more detailed embodiment of a merchant on-boarding fraud detection operation;

FIG. 4 is an illustrative flow chart depicting a merchant on-boarding risk mitigation operation in accordance with some embodiments; and

FIG. 5 is a block diagram that illustrates a computer system upon which embodiments described herein may be implemented.

### DETAILED DESCRIPTION

In the following description, numerous specific details are set forth such as examples of specific components, circuits, and/or processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

Examples described herein provide a system and method for detecting the creation of a fraudulent merchant profile during merchant on-boarding. As used herein, a “merchant” refers to a company or business (e.g., Wal-Mart, Pep Boys, McDonald's, Philz Coffee, etc.) that provides goods and/or services. Furthermore, a particular merchant may be associated with a single outlet (e.g., wherein the merchant is a store owner) or multiple outlets (e.g., wherein the merchant is a franchise). An “operator” herein refers to an actual user (e.g., director, manager, employee, or other type of personnel) that is associated with a particular merchant.

According to some embodiments, a system for conducting commercial transactions receives signup information from a merchant requesting to create a new merchant profile. The signup information may include input data specifying a bank account of the merchant and metadata associated with a device sued to submit the input data. The system compares the signup information with merchant information stored in a merchant database and selectively identifies the new merchant profile as fraudulent based, at least in part, on the comparison.

Among other benefits, examples described herein recognize that merchants or individuals (e.g., “fraudsters”) may attempt to defraud the transaction processing system by creating multiple merchant profiles. For example, a merchant may be limited to the number and/or amount of payments it can process through the system (e.g., this amount may be capped at $500/day for key-in transactions). Thus, a fraudster may attempt to circumvent the payment cap by creating multiple merchant profiles, thereby multiplying the amount of money they can potentially defraud. Under conventional implementations, a duplicate account is detected based on personally- or business-identifying information (e.g., name, address, phone number, etc.).

In contrast, examples herein recognize that fraudsters may provide false or inconsistent information when creating duplicate merchant profiles. However, fraudsters typically specify a valid back account (e.g., though routing information, account information, and/or account type) that they can withdraw funds from. Therefore, examples herein provide a mechanism for selectively identifying a new merchant profile as fraudulent by comparing the bank account specified by the merchant with bank account information associated with existing merchant profiles or known fraudulent profiles.

Examples described herein also recognize that, a fraudster may attempt to create a non-duplicate merchant profile under a false or stolen identity. For example, a fraudster may create a new merchant profile using the tax ID for a business that does not have an existing merchant profile with the system. In another example, a fraudster may set up a business with the sole purpose of defrauding the system. Therefore, examples herein further provide mechanisms for verifying the identity of a new merchant as well as assessing the social risk factors associated with one or more businesses owned or operated by the new merchant.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

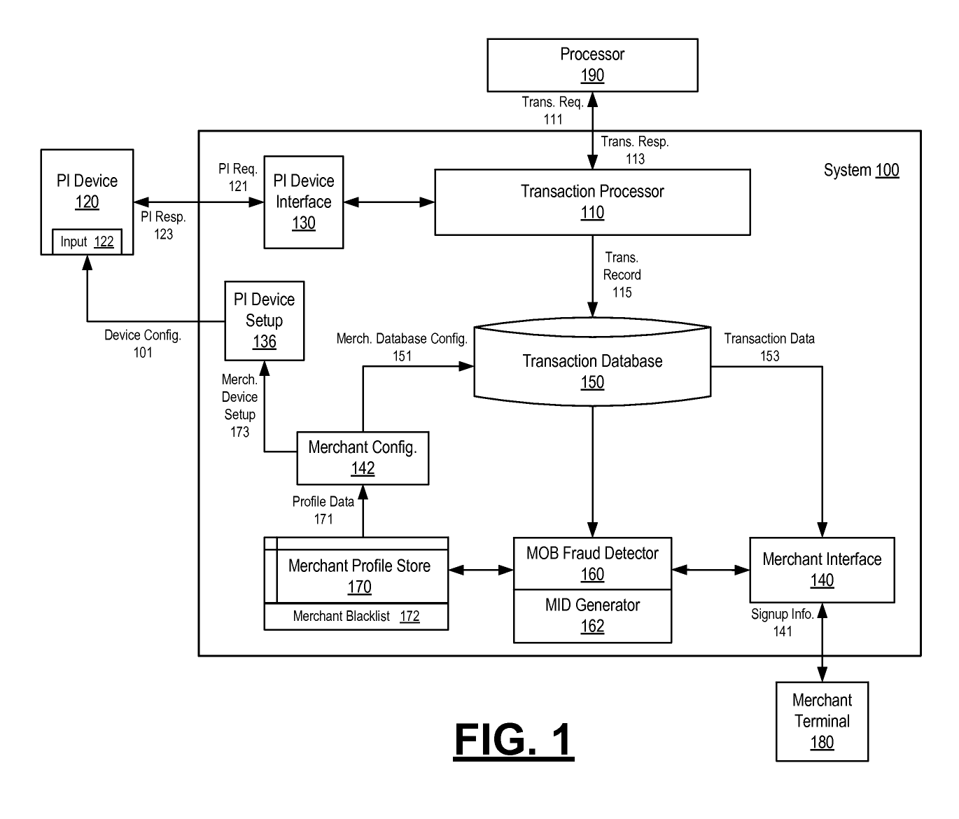

FIG. 1 illustrates an exemplary system for conducting commercial transactions in accordance with present embodiments. With reference to FIG. 1, a payment input (PI) device 120 can be operated by a merchant to access a transaction processing system 100. The PI device 120 may correspond to, for example, a point of sale (POS) device and/or a credit card terminal (CCT). The transaction processing system 100 can be provided as a network service, such as a cloud-based service, or software deployed in the merchant's data center. In one implementation, the transaction processing system 100 is a multi-tenant cloud-based service that hosts merchant transactional activity and services for multiple merchants.

According to some embodiments, the system 100 can include a transaction processing sub-system 110, a transaction database 150, and a merchant interface 140. A given merchant (or operator for the merchant) can access system 100 via merchant interface 140. For example, the merchant may access the system 100 over the Internet, using a web browser, and the interface 140 can be provided as a web page. During merchant “on-boarding” (i.e., the process by which a merchant registers with the system 100 and/or creates a new merchant profile), the merchant provides signup information 141 to the system 100, using a merchant terminal 180. The merchant terminal 180 may correspond to any computing device (e.g., computer, cell phone, tablet, PDA, etc.) capable of interacting with the system 100 via the merchant interface 140.

The signup information may include input data entered by the merchant, as well as metadata associated with the merchant terminal 180. More specifically, the input data may include personally-identifying information and/or business-identifying information. Examples of personally-identifying information include: a name, address, date of birth, social security number, phone number, email address, bank account, and/or password associated with an individual or operator. Examples of business-identifying information include: a name, address, phone number, web address, and/or tax ID associated with a company or business. Furthermore, the metadata may include information specifying a device type, device ID, internet protocol (IP) address, and/or geolocation coordinates of a location of the merchant terminal 180 when used to submit the input data.

For some embodiments, the merchant interface 140 may forward the received signup information 141 to a merchant on-boarding (MOB) fraud detector 160. The MOB fraud detector 160 analyzes the received signup information 141 to determine whether the new merchant profile is (or is likely to be) fraudulent. For example, the fraud detector 160 may compare the signup information 141 with existing merchant profile information stored in a merchant profile store 170 to determine whether the new merchant profile is a duplicate of an existing merchant profile. The fraud detector 160 may additionally compare the signup information 141 with blacklist data stored in a merchant blacklist 172 to determine whether the new merchant profile is associated with a blacklisted merchant.

For some embodiments, the MOB fraud detector 160 may request additional information from the merchant prior to creating (or registering) the new merchant profile. For example, the fraud detector 160 may retrieve out-of-wallet questions (e.g., “what year did you purchase your house,” “how much did you pay for your house,” “what model year is your car,” “on what street did you live in 1998,” etc.) for purposes of verifying the identity of the merchant. In another example, the fraud detector 160 may request access to and/or analyze one or more social networking profiles of the merchant (e.g., Facebook, Twitter, LinkedIn, etc.) to evaluate one or more social risk factors associated with the merchant (e.g., age of profiles, number of connections and/or friends, number and/or frequency of posts or interactions with other users).

Assuming the signup information 141 passes fraud detection, the MON fraud detector 160 may then create the new merchant profile, for example, by storing profile information for the merchant in the merchant profile store 170. The merchant profile may include some or all of the signup information 141. For example, each merchant profile may include a merchant identifier (MID), location identifiers, device identifiers, and/or role designations for the particular merchant. As an addition or alternative, the profile store 170 can also be used to maintain merchant-specified device configurations and information. For some embodiments, a merchant account generator 162 may assign a MID to the merchant prior to storing the new merchant profile in the merchant profile store 170. MIDs are typically issued by an acquiring bank to enable the merchant to use the acquiring bank's services in processing credit card transactions. Each MID is further associated with one or more terminal identifiers (TIDs) which are used to link the merchant's payment terminals with the corresponding merchant account.

In some instances, a merchant may have an existing merchant account (e.g., MID) with an acquiring bank. Thus, for some embodiments, the merchant interface 140 may allow the merchant to input its own MID/TID information. The MID generator 162 may mark the MID to indicate that it is a merchant-preferred MID. If the merchant does not have an existing MID, or has no preference regarding which acquiring bank and/or processor the system 100 uses to process transactions, the merchant account generator 162 may create a new merchant account with a default (e.g., pre-selected) acquiring bank and processor. Accordingly, the merchant account generator 162 may assign a new MID and one or more TIDs for the merchant.

The merchant may then associate one or more PI devices 120 for use with the system 100. For simplicity, only one PI device 120 is shown in exemplary embodiment of FIG. 1. The PI device 120 may be a software configurable device that can provide POS and/or CCT functionality through, for example, an application or programmatic interface. In such implementations the PI device 120 may correspond to a multi-purpose computing device, including mobile computing devices such as computers, smartphones, and/or tablets. For some embodiments, the PI device 120 may be configured with merchant-specific software configurations to enable various kinds of usages, including franchise-based usage where the merchant is a multi-point merchant. The merchant may associate the PI device 120 with a particular store location and/or one or more employees of that store (e.g., based on role assignments).

Once a merchant profile has been successfully created, a merchant configurator 142 retrieves profile data 143 stored in the merchant profile store 170 and generates device setup instructions 173 as well as database configuration instructions 151 for the merchant. The device setup instructions 173 may identify all of the PI devices associated with the merchant, and may include configuration instructions for each device. For example, the device setup instructions 173 may include a MID, one or more TIDs, and software and/or hardware configurations for enabling PI devices to create and process transactions through the system 100.

The PI device setup logic 136 receives the device setup instructions 173 from the merchant configurator 142 and generates device configuration instructions 101 for each PI device 120 associated with the merchant. The PI device setup logic 136 may determine, from the device setup instructions 173, how the PI device 120 is to be configured (e.g., which employee(s) may initiate transactions, what inventory items can be sold, what price is to be associated with each item, etc.). The device 120 may then request or retrieve the configuration instructions 101 from the PI device setup logic 136. The device configuration instructions 101 may include the TID assigned to the PI device 120 as well as device-specific software configuration instructions. For example, the device configuration instructions 101 may include a list of items that may be sold through PI device 120 and/or a list of employees that are allowed access (e.g., to log in) to PI device 120.

The database configuration instructions 151 include parameters (e.g., fields and/or tables) to be created for the merchant in the transaction database 150. For example, the database configuration instructions 151 may identify the merchant, store locations, inventory items, and/or employees associated with the merchant. The transaction database 150 may store information pertaining to a payment history (e.g., for successfully processed payments and/or chargebacks) for the merchant. For example, the database configuration instructions 151 may be used to create: a merchant field for storing data (e.g., merchant sales reports) pertaining to the merchant as a whole; one or more location fields that are linked or associated with the merchant field for storing data (e.g., location-based sales reports) specific to a particular store and/or location; and one or more inventory and employee fields that are linked or associated with each store location field for storing inventory and employee records (e.g., transaction records) from a particular PI device associated with that store location. For some embodiments, individual operators may only be allowed selective access to the information stored in the transaction database 150 (e.g., based on their particular role assignments).

Once the merchant configurator 142 has finished setting up the PI device 120 and transaction database 150, a transaction can be initiated through the given PI device 120. An employee or operator of the PI device 120 may create a transaction for a particular store item on the PI device 120. For example, the employee may specify the item(s) and quantity to be sold via a user interface (UI) provided on the PI device 120. The employee may then input the customer's payment information (e.g., credit card account number, expiration date, cardholder's name, etc.) via an input mechanism 122.

For some embodiments, the input mechanism 122 may be a card reader which receives inputs in the form of a card “swipe.” For example, most credit cards are issued in the form of a magnetic stripe card wherein credit card information (e.g., card or account number, cardholder's name, expiration date, etc.) is stored on a magnetic stripe (“magstripe”) on the reverse side of the card. When the credit card is swiped, the input mechanism 122 may read the credit card information stored on the magstripe and forward this data to the PI device 120 for further processing. For example, the input mechanism 122 may be a peripheral device that is connected or coupled to the PI device 120. Alternatively, the input mechanism 122 may be integrated with the PI device 120.

As an additional or alternative embodiment, the input mechanism 122 may be configured to receive character-based inputs. For example, the input mechanism 122 may include a keyboard or keypad which enables the user to manually “key in” a customer's credit card number and/or other information. As described in greater detail below, for some embodiments, transactions may be processed differently depending on the type of input mechanism used. For example, if the input mechanism 122 is a card reader, a customer must physically produce a credit card to be input (e.g., swiped) into the card reader. Thus, a card swipe input may confirm that the credit card was actually in the customer's possession when the transaction was made, whereas a keyed-in input could not. Card swipe inputs are therefore considered more secure, in general, than keyed-in inputs.

Upon receiving payment information, the PI device 120 signals a PI request 121 to system 100 through a network such as the Internet. The PI request 121 may include the customer's payment information, as well as additional information pertaining to the desired transaction. For example, the PI request 121 may include information identifying the items (including quantity of each item) being purchased, itemized cost of the transaction (including any discounts that may have been applied), the location of the PI device 120, employee metadata (identifying the employee making the sale), and merchant metadata (e.g., MID/TID).

The PI request 121 is sent to a PI device interface 130 which then forwards the request 121 to the transaction processor 110. For some embodiments, the PI device interface 130 may selectively assign a payment processor to process payment information from the PI request 121 depending on a merchant preference. For example, as discussed above, the merchant may have a pre-existing MID with a processor that it wishes to use for all credit card transactions. Accordingly, the PI device interface 130 may parse the merchant metadata from the PI request 121 to first determine whether the merchant has selected to use its own existing MID/TID, or whether a new MID/TID was assigned by the MID generator 162. For example, if PI request 121 includes a merchant-preferred MID, the PI device interface 130 may simply forward the request 121 on to the transaction processor 110 without modification. Accordingly, the PI device interface 130 may dynamically associate the PI device 120 with a new payment processor (e.g., by altering the MID/TID information of the PI request 121) only if a new MID/TID was assigned by the MID generator 162 and/or the merchant did not indicate a preference for a particular payment processor.

The transaction processor 110 receives the PI request 121 and transmits a transaction request 111 to a corresponding payment processor 190 based on the MID/TID information included with the PI request 121 and/or routing information provided by the PI device interface 130. For some embodiments, the transaction processor 110 may perform a number of authentication and/or verification operations on the received PI request 121 prior to even generating a transaction request 111. For example, the transaction processor 110 may first verify that: the merchant operator initiating the transaction is permitted to make such a sale; the item(s) being sold are properly associated with the merchant that is selling them; and whether a credit card was physically used to make the purchase. For some embodiments, the transaction processor 110 may limit the amount that may be transacted (e.g., in a day, week, month, and/or year) if the payment information was keyed in manually, for example, by blocking any transaction that would exceed the transaction limit associated with the received payment information.

Once a PI a request 121 has been authenticated, the transaction processor 110 stores a record of the transaction (e.g., transaction record 115) in the transaction database 150. The transaction processor 110 then transmits the transaction request 111 to the payment processor 190. The transaction request 111 may include the customer's payment information (e.g., credit card number, expiration date, cardholder's name, etc.) and other transaction information (e.g., items purchased, price paid, merchant information, etc.). For some embodiments, the transaction processor 110 may send the transaction request 111 to any one of multiple payment processors based on the MID/TID information included with the PI request 121.

The payment processor 190 then acquires the funds (i.e., the requested payment) on behalf of the merchant. For example, the payment processor 190 may route the transaction request 111 through the appropriate card network (e.g., Visa, MasterCard, American Express, Discover, etc.) to the issuing bank. The issuing bank authenticates the transaction request 111 and responds by either approving or declining the transaction. For example, the issuing bank may verify that the transaction information is valid, the customer has sufficient credit to make the purchase, and the customer's account with the issuing bank is in good standing. This process is known as “authorization.” If the issuing bank approves the transaction, it may place a hold on the funds to be transferred to the acquiring bank. The issuing bank returns a transaction response 113 (e.g., approved/declined), which is routed back through the processor 190 and sent to the transaction processor 110.

The transaction processor 110 stores the transaction response 113 with the associated transaction record 115, awaiting settlement. For some embodiments, if the issuing bank 172 declines a transaction, the transaction processor 110 may send a PI response 123 to the PI device 120 indicating that the transaction was declined and delete the transaction record 115 associated therewith. Alternatively, the transaction processor 110 may write to the stored transaction record 115 indicating that the corresponding transaction was declined.

The transaction processor 110 may subsequently initiate a “settlement” process (e.g., which typically occurs at the end of each business day) to capture the held funds. For example, the transaction processor 110 may route information identifying the approved transactions back to the issuing bank, via the processor 190. The issuing bank then deposits the appropriate funds in a master merchant account of an acquiring bank associated with a system operator (i.e., the operator of the transaction processing system 100). The amount deposited in the master merchant account may be equal to the gross receipts (i.e., the amount owed by customers) less interchange/network fees owed to the card network and processing fees owed to the processor 190 (and/or acquiring bank). Finally, the acquiring bank deposits the funds acquired by the master merchant account to a particular merchant's deposit account. For some embodiments, the transaction processor 110 may control or manage the transfer of funds from the master merchant account to the merchant deposit account. For example, the transaction processor 110 may instruct the acquiring bank to deduct the system operator's transaction fees from the amount deposited to the merchant deposit account. The system operator's transaction fees may thus be retained in the master merchant account.

To access transaction data 153 stored in the transaction database 150, an operator first logs in through the merchant interface 140. For some embodiments, the merchant interface 140 may determine the operator's role assignment and retrieve role-specific data. For example, the role-specific data may include selected data items from the transaction database 150 that the particular operator is allowed access to, based on the operator's role assignment.

Methodology

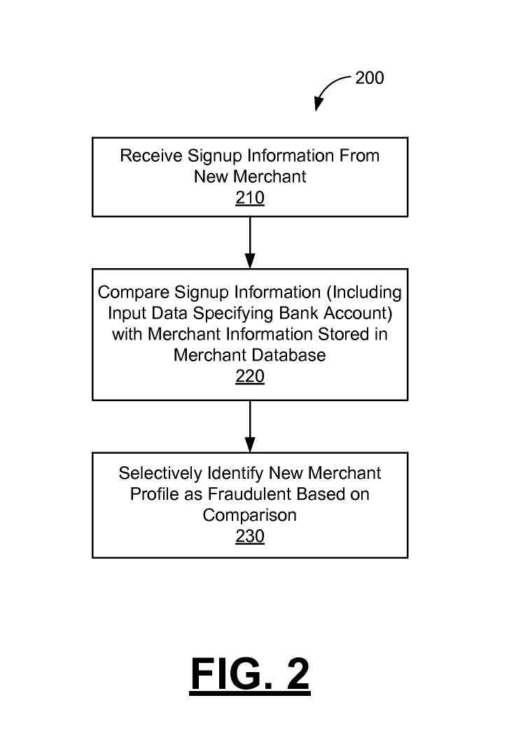

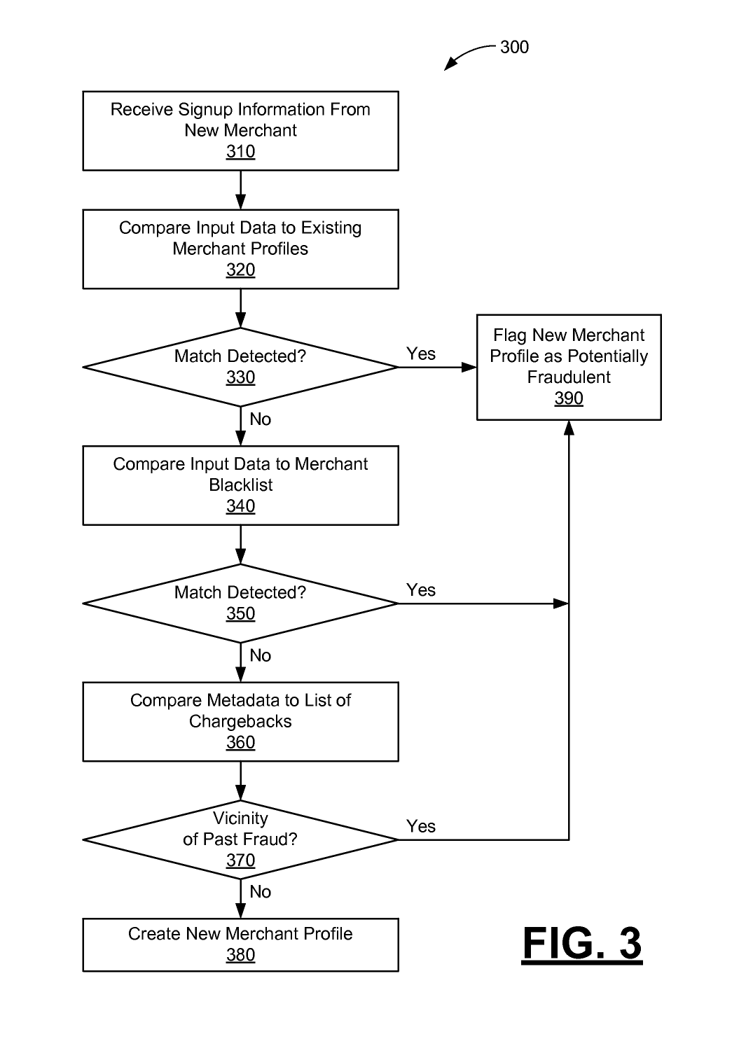

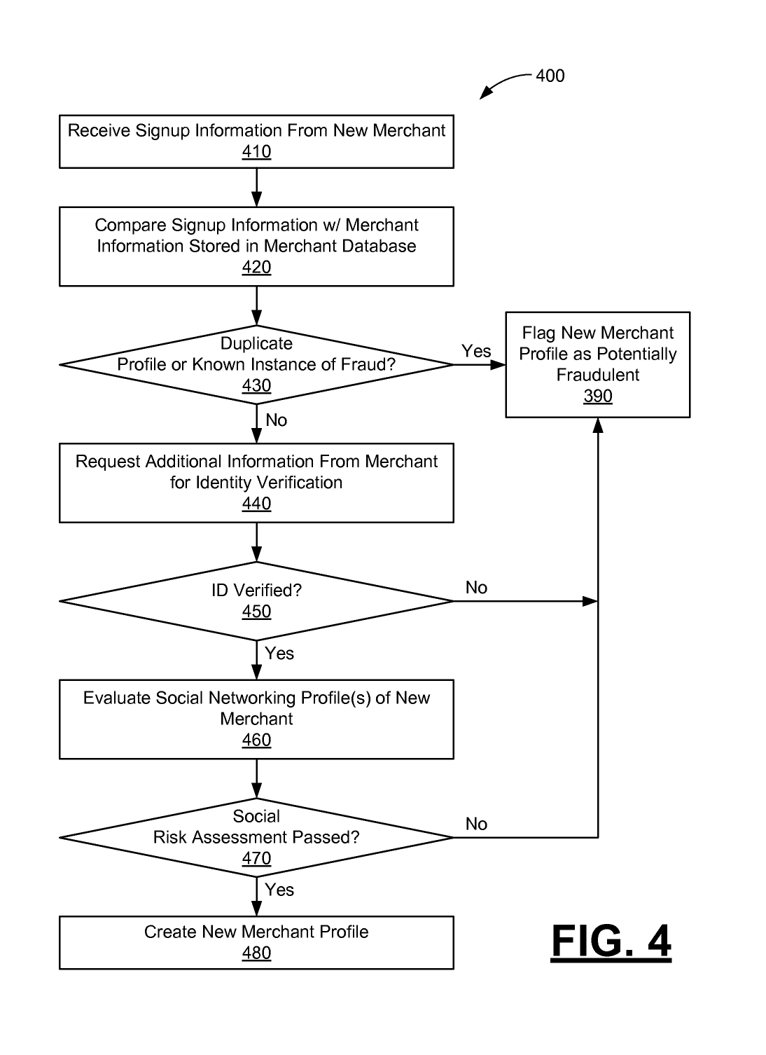

FIGS. 2 and 3 are illustrative flow charts depicting a merchant on-boarding fraud detection operation in accordance with some embodiments. FIG. 4 is an illustrative flow chart depicting a merchant on-boarding risk mitigation operation in accordance with some embodiments. Methods such as described by examples of FIGS. 2-4 may be implemented using, for example, a system such as described with respect to FIG. 1. Accordingly, reference may be made to elements of FIG. 1 for purpose of illustrating suitable components for performing a step or sub-step being described.

FIG. 2 is an illustrative flow chart 200 depicting a merchant on-boarding fraud detection operation in accordance with some embodiments. With respect to FIG. 2, the system 100 initially receives signup information from a new merchant (210). For example, the signup information may include input data entered by the merchant using the merchant terminal 180, and metadata associated with the merchant terminal 180. The input data may include personally-identifying information and/or business-identifying information pertaining to the merchant (e.g., as described above, with reference to FIG. 1). For some embodiments, the input data specifies a bank account for the merchant (i.e., a personal bank account and/or a merchant deposit account). The bank account information may include, for example, routing information, account information, and/or account type.

The system 100 then compares the received signup information with merchant information stored in a merchant database (220). For example, the MOB fraud detector 160 may compare the signup information with existing merchant profile information stored in the merchant profile store 170 and/or blacklist data stored in the merchant blacklist 172. In particular, the fraud detector 160 may compare the received bank account information with other bank account information associated with existing merchant profiles to determine whether the new merchant profile is a duplicate of an existing profile. The fraud detector 160 may also compare the received bank account information with bank account information associated with known fraudulent profiles to determine whether the merchant's bank account has been associated with known instances of fraud.

Finally, the system 100 may selectively identify the new merchant profile as fraudulent based on the comparison (230). For example, the MOB fraud detector 160 may identify the new merchant profile as fraudulent upon determining that it is a duplicate of an existing profile in the merchant profile store 170. The fraud detector 160 may also identify the new merchant profile as fraudulent upon determining a link to one or more known instances of fraud.

FIG. 3 is an illustrative flow chart 300 depicting a more detailed embodiment of a merchant on-boarding fraud detection operation. With reference, for example, to FIG. 1, the system 100 first receives signup information from a new merchant (310). As described above, the signup information may include input data (i.e., personally- and/or business-identifying information) entered by the merchant and metadata associated with the device used by the merchant to submit the input data (e.g., merchant terminal 180). Personally-identifying information may include, for example, a name, address, date of birth, social security number, phone number, email address, bank account, and/or password associated with an individual or operator. Business-identifying information may include, for example, a name, address, phone number, web address, and/or tax ID associated with a company or business. Furthermore, metadata may include information specifying a device type, device ID, IP address, and/or geolocation coordinates of a location of the device used by the merchant when submitting the input data.

The system 100 then compares the input data with existing merchant profiles stored in the merchant profile store 170. For example, the MOB fraud detector 160 may compare one or more items of input data (e.g., name, address, phone number, etc.) with merchant profile information stored in the merchant profile store 170. If a match is detected (330), the system 100 may flag the new merchant profile as potentially fraudulent (390). More specifically, detecting a match between the input data and an existing merchant profile may indicate that the merchant is attempting to create a duplicate profile. Therefore, unless the duplicate profile has been previously approved by a system administrator, it is likely that the merchant is attempting to defraud the system 100 (e.g., by circumventing the transaction limit for key-in payments).

If no match is detected between the input data and any of the existing merchant profiles (330), the system 100 may subsequently compare the input data to a merchant blacklist (340). For example, the fraud detector 160 may compare one or more items of input data (e.g., name, address, phone number, etc.) blacklist data stored in the merchant blacklist 172. If a match is detected (350), the system 100 may flag the new merchant profile as potentially fraudulent (390). More specifically, detecting a match between the input data and the blacklist data may indicate that the merchant has been previously associated with one or more known incidents of fraud. Therefore, unless the new merchant profile has been previously approved by a system administrator, it is likely that the merchant is attempting once again to defraud the system 100.

If no match is detected between the input data and the merchant blacklist (350), the system 100 may then compare the received metadata to a list of prior chargebacks. Chargebacks correspond to disputed transactions that resulted in the system 100 returning funds (i.e., from the master merchant account) to an individual cardholder's account because his/her credit card was charged without authorization (e.g., the credit card was copied or stolen). The list of chargebacks may be stored, for example, along with other payment history information in the transaction database 150. If a particular merchant profile has too many chargebacks associated therewith, it is likely that a fraudster acquired a list of stolen credit card information and set up the merchant profile for the purpose of processing payments using that information.

For some embodiments, the fraud detector 160 may compare the geolocation data (provided in the metadata) with location information associated with the list of chargebacks to determine whether the merchant is attempting to create the new merchant profile in the vicinity of a location where fraudulent activity was previously detected. If the merchant is within a threshold distance of a location of past fraud (370), the system 100 may identify the new merchant profile as potentially fraudulent (390). Otherwise, the system 160 may create the new merchant profile (380), for example, by storing at least a portion of the signup information in the merchant profile store 170.

For some embodiments, the system 100 may take additional precautions upon detecting a fraudulent merchant profile. For example, in addition to flagging or identifying the new merchant profile as potentially fraudulent (390), the MOB fraud detector 160 may proceed by cancelling the new merchant profile and/or notifying the system administrator that a potentially fraudulent merchant profile was (or was attempted to be) created. For some embodiments, the fraud detector 106 may also notify the merchant that the new merchant profile was not created and/or disclose the reasons why (e.g., duplicate account exists, associated with known fraudulent profile, location within vicinity of past fraud).

FIG. 4 is an illustrative flow chart 400 depicting a merchant on-boarding risk mitigation operation in accordance with some embodiments. With reference, for example, to FIG. 1, the system 100 first receives signup information from a new merchant (410). As described above, the signup information may include input data entered by the merchant and metadata associated with the device used by the merchant to submit the input data.

The system 100 then compares the signup information with merchant information stored in a merchant database (420). For example, as described above with reference to FIG. 3, the MOB fraud detector 160 may compare the signup information with existing merchant profile information stored in the merchant profile store 170 (e.g., to determine whether the new merchant profile is a duplicate of an existing profile) and/or blacklist data stored in the merchant blacklist 172 (e.g., to determine whether the merchant has been blacklisted or associated with known instances of fraud). If the system 100 determines that the new merchant profile is a duplicate of an existing profile or is associated with one or more known instances of fraud (430), the system 100 may flag the new merchant profile as potentially fraudulent (490).

If the new merchant profile is not a duplicate of an existing profile and is not associated with one or more known instances of fraud (430), the system 100 may request additional information from the merchant for purposes of verifying the merchant's identity (440). For example, a fraudster may attempt to create a new merchant profile under a false or stolen identity (e.g., using the tax ID for a legitimate business not previously associated with the system 100). Accordingly, the fraud detector 160 may prompt the merchant to answer one or more out-of-wallet questions based on private and/or personal information that only the merchant (or an operator closely associated with the merchant) is likely to know. Examples of out-of-wallet questions may include: “what year did you purchase your house,” “how much did you pay for your house,” “what model year is your car,” and/or “on what street did you live in 1998.” for purposes of verifying the identity of the merchant. For some embodiments, at least a portion of the identity verification process may be outsourced to a third party (e.g., IDology) that specializes in verifying the identity of merchants or individuals. If the system 100 is unable to verify the identity of the merchant (450), it may flag the new merchant profile as potentially fraudulent (490).

If the merchant identity is successfully verified (450), the system 100 may proceed to evaluate one or more social networking profiles associated with the merchant. For example, merchants with no social networking profiles (e.g., Facebook, Twitter, LinkedIn, etc.), or only recently-created profiles, may pose a higher risk of fraud than merchants with older and more established profiles. Similarly, merchants with very few connections (e.g., friends, contacts, followers, etc.) and/or little activity (e.g., posts, comments, likes, etc.) may also pose a greater risk of fraud than merchants that are more active and well-connected. For some embodiments, the fraud detector 160 may request access (e.g., login and password) to view information pertaining to the social networking profiles of the merchant. The fraud detector 160 may then generate a social risk assessment score, based on a combination of the factors above, and compare the score against a risk threshold. If the merchant fails the social risk assessment (e.g., the social risk assessment score is above the risk threshold) (470), the system 100 may flag the new merchant profile as potentially fraudulent (490).

If the merchant passes the social risk assessment (e.g., the social risk assessment score is below the risk threshold) (470), the system 100 may create the new merchant profile (480). For some embodiments, the system 100 may take additional precautions if a potentially fraudulent merchant profile is detected, for example, by cancelling the new merchant profile and/or notifying the system administrator that a potentially fraudulent merchant profile was attempted to be created. Further, the system 100 may also notify the merchant that the new merchant profile was not created and/or disclose the reasons why.

Computer System

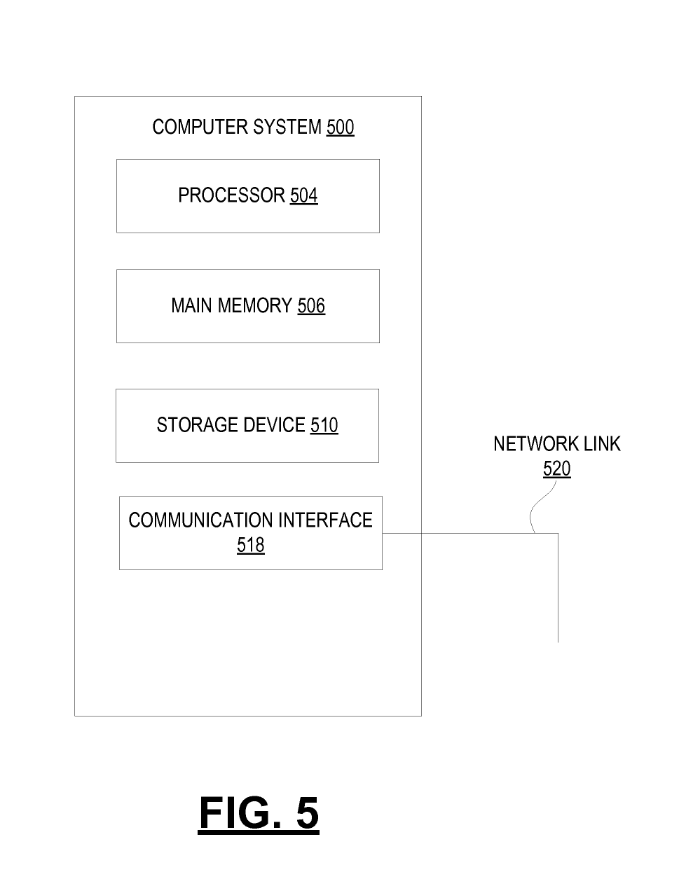

FIG. 5 is a block diagram that illustrates a computer system upon which embodiments described herein may be implemented. For example, in the context of FIG. 1, system 100 may be implemented using one or more servers such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wired line). The communication interface 518 may communicate with merchants and operators using, for example, the Internet.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for configuring a merchant profile for commercial transactions, the method being implemented by one or more processors and comprising:
receiving signup information from a merchant requesting to create a new merchant profile, wherein the signup information includes (i) input data specifying a bank account and (ii) metadata associated with a device used to submit the input data;
comparing the signup information with merchant information stored in a merchant database, including comparing the bank account specified by the input data with bank account information associated with existing merchant profiles or known fraudulent profiles; and
selectively identifying the new merchant profile as fraudulent based, at least in part, on the comparison.

2. The method of claim 1, wherein selectively identifying the merchant profile as fraudulent comprises:
identifying the new merchant profile as fraudulent if the bank account specified by the input data matches the bank account information associated with an existing merchant profile or a known fraudulent profile.

3. The method of claim 1, wherein comparing the signup information with merchant information stored in the merchant database includes:
comparing the signup information with the merchant information associated with one or more existing merchant profiles to determine whether the new merchant profile is a duplicate of one of the existing merchant profiles.

4. The method of claim 1, wherein comparing the signup information with merchant information stored in the merchant database includes:
comparing the signup information with a merchant blacklist to determine whether the merchant has been previously associated with a known fraudulent profile.

5. The method of claim 4, wherein the metadata includes geolocation data indicating a location of the device when used to submit the input data, and wherein comparing the input data and metadata with blacklist data includes:
comparing the received geolocation data with geolocation data associated with one or more payments or chargebacks previously identified as fraudulent; and
determining that the merchant is blacklisted if the location of the device is within a threshold distance of a location where a fraudulent payment or chargeback previously occurred.

6. The method of claim 1, further comprising:
requesting additional information from the merchant, wherein the request includes out-of-wallet questions; and
determining the veracity of the input data based on the additional information.

7. The method of claim 1, further comprising:
analyzing one or more social networking profiles associated with the merchant; and
determining a social risk assessment for the merchant based on the one or more social networking profiles.

8. The method of claim 1, wherein the input data specifying the bank account includes at least one of: routing information, account information, or account type.

9. The method of claim 1, wherein the input data further includes personally-identifying information, including at least one of: a name, address, date of birth, social security number, phone number, email address, or password.

10. The method of claim 1, wherein the input data further includes business-identifying information, including at least one of: a name, address, phone number, web address, or tax ID.

11. The method of claim 1, wherein the metadata includes information identifying at least one of: a device type, device ID, IP address, or geolocation data indicating a location of the device when used to submit the input data.

12. A computer system comprising:
a memory that stores instructions;
one or more processors, which access instructions from the memory to perform operations including:
receive signup information from a merchant requesting to create a new merchant profile, wherein the signup information includes (i) input data specifying a bank account and (ii) metadata associated with a device used to submit the input data;
compare the signup information with merchant information stored in a merchant database, including comparing the bank account specified by the input data with bank account information associated with existing merchant profiles or known fraudulent profiles; and
selectively identify the new merchant profile as fraudulent based, at least in part, on the comparison.

13. The computer system of claim 12, wherein the one or more processors selectively identify the new merchant profile as fraudulent by:
identifying the new merchant profile as fraudulent if the bank account specified by the input data matches the bank account information associated with an existing merchant profile or a known fraudulent profile.

14. The computer system of claim 12, wherein the one or more processors compare the signup information with merchant information stored in the merchant database by:
comparing the signup information with the merchant information associated with one or more existing merchant profiles to determine whether the new merchant profile is a duplicate of one of the existing merchant profiles.

15. The computer system of claim 12, wherein the one or more processors compare the signup information with merchant information stored in the merchant database by:
comparing the signup information with a merchant blacklist to determine whether the merchant has been previously associated with a known fraudulent profile.

16. The computer system of claim 15, wherein the metadata includes geolocation data indicating a location of the device when used to submit the input data, and wherein the one or more processors compare the input data and metadata with blacklist data by:
comparing the received geolocation data with geolocation data associated with one or more payments or chargebacks previously identified as fraudulent; and
determining that the merchant is blacklisted if the location of the device is within a threshold distance of a location where a fraudulent payment or chargeback previously occurred.

17. The computer system of claim 12, wherein the memory further includes instructions that cause the one or more processors to perform operations including:
request additional information from the merchant, wherein the request includes out-of-wallet questions; and
determine the veracity of the input data based on the additional information.

18. The computer system of claim 12, wherein the memory further includes instructions that cause the one or more processors to perform operations including:
analyzing one or more social networking profiles associated with the merchant; and
determining a social risk assessment for the merchant based on the one or more social networking profiles.

19. The computer system of claim 12, wherein the input data specifying the bank account includes at least one of: routing information, account information, or account type.

20. A computer-readable medium that stores instructions that, when executed by one or more processors, cause the one or more processors to perform operations comprising:
receiving signup information from a merchant requesting to create a new merchant profile, wherein the signup information includes (i) input data specifying a bank account and (ii) metadata associated with a device used to submit the input data;
comparing the signup information with merchant information stored in a merchant database, including comparing the bank account specified by the input data with bank account information associated with existing merchant profiles or known fraudulent profiles; and
selectively identifying the new merchant profile as fraudulent based, at least in part, on the comparison.
